(19) United States
(12) Patent Application Publication
(10) Pub. No.: US 2005/0160125 A1
(43) Pub. Date: Jul. 21, 2005

(54) Dynamic filter

(75) Inventors: Glen F. Chatfield, Bradfordwoods, PA (US); Dale K. Wells, Eighty Four, PA (US)

Correspondence Address: THE LAW OFFICE OF RICHARD W. JAMES, 25 CHURCHILL ROAD, CHURCHILL, PA, 15235, US

(73) Assignee: OPTIMUM Power Technology

(21) Appl. No.: 11/037,299

(22) Filed: Jan. 18, 2005

Related U.S. Application Data
(60) Provisional application No. 60/537,227, filed on Jan. 17, 2004.

(51) Int. Cl. G06F 17/10

(52) U.S. Cl. 708/300

(57) ABSTRACT

A system, an apparatus, and a method for dynamically filtering a signal. The system, apparatus, and method include providing a portion of a previously determined value and a portion of a currently determined value, the portions depending on a magnitude of change between those previously and currently determined values.

### CROSS-REFERENCE TO RELATED APPLICATIONS

Not applicable.

### STATEMENT REGARDING FEDERALLY SPONSORED RESEARCH

Not applicable.

### BACKGROUND

1. Field of the Invention

The disclosed invention relates to a filter in general and, in particular, to a filter to minimize small signal fluctuations while reacting quickly to larger signal fluctuations.

2. Description of the Background

A filter, as the term is used in the signal conditioning technology, may suppress noise existing on a signal or may average an oscillating or unsteady signal or may do both simultaneously. Such a filter may be implemented in software where, for example, portions of a signal that has been converted to digital information may be manipulated by way of instructions executed by a processor. Such a filter may alternately be implemented in hardware that may, for example, manipulate an analog signal carrying analog or digital information directly. When implemented in hardware, the filtered signal may be converted into digital information after passing through and being manipulated by a hardware filter.

In data acquisition systems, undesirable noise is often generated by a sensor or its wiring that skews the value read from the actually sensed value. For example undesirable signal distortion can result from the vibration of mechanical sensors or from systems that operate unsteadily. For example, unsteady piston velocity is generally encountered in connection with a piston engine that moves at varying speeds in its normal travel or in an engine wherein every combustion event is different causing the engine to operate with some irregularity in speed or rpm from cycle to cycle. It is thus often desirable to apply a filter to such a signal to remove forms of distortion including variations caused by vibration or to convert unsteady signals to steady signals. At the same time, however, it is also desirable to permit significant changes in a signal value not caused by distortion or unsteady signals to pass through the filter unchanged or while minimally affecting the value.

Thus, there is a need for a filter apparatus and a method to minimize small signal fluctuations while reacting quickly to larger signal fluctuations.

### SUMMARY

The present invention is directed to a dynamic filter that alters the amount of filtering provided dependent upon a magnitude of change occurring in a signal. The dynamic filter may be applied to an input signal received at a data acquisition unit or another value received by or determined by the data acquisition unit. The term “determined value” is meant to include any value, current or previous, raw or filtered, unprocessed or processed and may include, for example, sensed signals and values, and values determined otherwise such as by calculation by a data acquisition unit, an engine control unit, or another device. The dynamic filter minimizes small signal fluctuations while reacting quickly to larger signal fluctuations. In operation, the dynamic filter determines a relative magnitude of change from a filtered value or a previous determined value that may be associated with a signal from a sensor to a current value that may be associated with the signal from the sensor and provides a filtered value nearer the current value when the relative magnitude of change is great and nearer the previous filtered value or previous determined value when the magnitude of change is less.

The present invention is also directed to a method of dynamically filtering a signal. That method includes combining a portion of a previously determined value that may be associated with a signal with a portion of a currently determined value that may be associated with the signal, the portions varying dependent on a magnitude of change between the previously determined value and the currently determined value.

In an embodiment, a filtered value includes a portion of a previously determined value and a portion of a currently determined value, the portions of the previously determined value and the currently determined value varying dependent on a magnitude in change between the previously determined value and the currently determined value such that the filtered value is biased toward the previously determined value when the magnitude of change is small and the filtered value is biased more toward the currently determined value when the magnitude of change is larger.

In another embodiment, a filter includes a processor executing instructions that cause the processor to receive a current value, retain a previous value, and create a filtered value including a portion of the current value and a portion of the previous value. The portions of the previous value and the current value furthermore vary dependent on a magnitude of change between the previous value and the current value such that the filtered value is biased toward the previous value when the magnitude of change is small and the filtered value is biased more toward the current value when the magnitude of change is larger.

In yet another embodiment, a filter includes a magnitude of change module that determines a magnitude of change from a previously determined value to a currently determined value, a dynamic filter variable module that relates the magnitude of change to a relative value, and a filter value module that applies the relative magnitude of change to the magnitude of change and combines the result with the previously determined value to arrive at a filtered value, wherein the filtered value is biased toward the previously determined value when the magnitude of change is small and the filtered value is biased more toward the currently determined value when the magnitude of change is larger.

An embodiment of a method of filtering a value includes combining a portion of a previously determined value with a portion of a currently determined value, the portions of the previously determined value and the currently determined value varying dependent on a magnitude of change between the previously determined value and the currently determined value such that the filtered value is biased toward the previously determined value when the magnitude of change is small and biased more toward the currently determined value when the magnitude of change is larger.

In an embodiment, a computer readable medium has instructions stored thereon. When the instructions are executed by a processor, they cause the processor to receive a current value, retain a previous value, and create a filtered value including a portion of the current value and a portion of the previous value. The portions of the previous value and the current value furthermore vary dependent on a magnitude in change between the previous value and the current value such that the filtered value is biased toward the previous value when the magnitude of change is small and biased more toward the current value when the magnitude of change is larger.

Thus, the dynamic filter provides a method and apparatus for altering the amount of filtering provided dependent upon a magnitude of change occurring in a filtered signal.

Accordingly, the present dynamic filter provides solutions to the shortcomings of prior filtering devices. Those of ordinary skill in the art will readily appreciate, therefore, that other details, features, and advantages will become further apparent in the following detailed description of the preferred embodiments.

### BRIEF DESCRIPTION OF THE DRAWINGS

The accompanying drawings, wherein like reference numerals are employed to designate like parts or steps, are included to provide a further understanding of the dynamic filter, are incorporated in and constitute a part of this specification, and illustrate embodiments of the dynamic filter that together with the description serve to explain the principles of the dynamic filter.

In the drawings:

FIG. 1 illustrates an embodiment of a dynamic filter;

FIG. 2 illustrates an embodiment of a method of dynamically filtering a signal; and

FIG. 3 illustrates an embodiment of an engine control system in which the dynamic filter may be employed.

### DETAILED DESCRIPTION

Reference will now be made to embodiments of systems, apparatuses, and methods to filter a signal to minimize small signal fluctuations while reacting quickly to larger signal fluctuations. Examples of such filter embodiments are illustrated in the accompanying drawings. Details, features, and advantages of those filter embodiments will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

It is to be understood that the figures and descriptions included herein illustrate and describe elements that are of particular relevance to the dynamic filter, while eliminating, for purposes of clarity, elements found in typical data acquisition systems that are often utilized in connection with the dynamic filter. Because the construction and implementation of such other elements are well known in the art, and because a discussion of them would not facilitate a better understanding of the dynamic filter, a discussion of those elements is not provided herein. It is also to be understood that the embodiments of the dynamic filter that are described herein are illustrative only and are not exhaustive of the manners of embodying the dynamic filter. For example, it will be recognized by those skilled in the art that the dynamic filter may be readily adapted to provide a filtered signal in many applications other than internal combustion engine sensing applications.

A certain type of filter operates by averaging a plurality of values to arrive at a filtered value. For example, when a value is to be filtered, but not in real time, a value may be averaged with a number of values preceding that value and the same number of values following that value. Thus, for example, a five-point filtered average value may be equal to a sensed value added to two sensed values immediately preceding the sensed value and two sensed values immediately following the sensed value and the total may be divided by the number of sensed values summed, five in that example.

When operating in real-time, a filtered average value may be equal to a current value added to a plurality of previously determined values. Thus, for example, a four-point real-time filtered average value may be equal to the sum of a current sensed value and three sensed values determined just prior to that current sensed value divided by four. It should be recognized, however, that such a four-point real-time filtered average will require the receipt of four sensed values before the filter becomes fully effective. For example, in an automotive application where throttle position is the sensed characteristic and vibration causes the sensed throttle position to vary slightly even when the throttle is held steady, a transition from one throttle position to another may include the following sensed throttle position values: 23%, 22%, 23%, 21%, 35%, 34%, 35%, and 36%. The 23%, 22%, 23%, 21% sensed values may correspond to a constant throttle position so that filtering may be beneficial to minimize fluctuations due to vibration and the 35% sensed value may be an actual change in throttle position made by an operator wishing to change the load on the engine, with the 34%, 35%, and 36% sensed values corresponding to a throttle position maintained at approximately 35%. Applying the four-point real-time filtered average to those throttle positions, the filtered value when the 21% position was sensed would be 23%+22%+23%+21%/4, which is equal to 22.25%; the filtered value when the first 35% position was sensed would be 22%+23%+21%+35%/4, which is equal to 25.25%; the filtered value when the 34% position was sensed would be 23%+21%+35%+34%/4, which is equal to 28.25%; the filtered value when the second 35% position was sensed would be 21%+35%+34%+35%/4, which is equal to 31.25%; and the filtered value when the 36% position was sensed would be 35%+34%+35%+36%/4, which is equal to 35%. That example illustrates that an averaging filter applied to a throttle position sensor would provide sluggish response to a change in throttle position. The change in throttle position from 21% to 35% resulted in an initial filtered throttle position of 25.25%, and would provide a desired filtered value of 35% only after three additional sensed values are determined. Such poor performance could affect engine operation and emission controls by, for example, having fuel quantity provided to the engine not match air flow into the engine.

Another type of filter operates by combining a portion of a current signal value with a portion of a previous filtered signal value. In an embodiment, the portions of the current signal value and the previous filtered signal value may be determined by a filter constant. Such a filter may use a single value that is representative of one or more previous values. Where a single previous filtered value is used to represent multiple previous values, that single previous filtered value may be an average of the previous values or may weight those values as desired. By retaining the previous filtered value, only a single historic value need be retained and yet the previous filtered value may include some portion of some or all previously determined values with greater weight on recently determined values and little weight on earlier determined values. That filtered value may thus represent the last sensed value and, to a successively lesser extent, a series of values preceding the last sensed value.

For example, a filtered value that includes a portion of a previous filtered value and a portion of a current value may be determined by multiplying a filter constant by the difference between the previous filtered value and the current input value and adding the previous filtered value to the result, as illustrated in Equation 1.
FVc=FVp+FC(Vc−FVp) Constant Filter Equation 1
wherein:
FVc is the current filtered value;
FVp is the previous filtered value;
FC is the filter constant; and
Vc is the currently determined value.

The filter constant is normally assigned a value within the range from zero to one, wherein a value of zero provides a current filtered value equal to the previous filtered value and a value of one provides a current filtered value equal to the currently determined value. It should be noted that the result of Equation 1 with those limits on the filter constant includes a portion from zero to one of the previous filtered value and a portion from zero to one of the current value with the total of the portions of the previous filtered value and the current filtered value equaling one.

A filter constant value of 0.5 will therefore provide equal weighting between the previous filtered value and the current determined value with values between 0.0 and 0.5 being weighted more heavily toward the previous filtered value and values between 0.5 and 1.0 being more heavily weighted toward the currently determined value.

Equation 1 may alternately be represented in various ways including a representation in which a filter constant having a value of zero provides the currently determined value and a filter constant having a value of one provides the previous filtered value, as illustrated in Equation 2.
FVc=Vc+FC(FVp−Vc). Alternative Constant Filter Equation 2

The filter of either Equation 1 or 2 generally beneficially reduces the effect of small changes in a signal. Those changes may be caused, for example, by vibration or unsteady operation. For example, when measuring a position of a throttle in an automotive application, an operator of the vehicle may maintain a constant throttle position. The sensed position of the throttle as transmitted to an engine control unit, however, may vary over a small range with changes indicated at the engine control unit in nearly every sample of the sensed throttle position, as seen in connection with the throttle position example provided in connection with the averaging filter above. If those nearly continuously indicated changes in position were utilized by the engine control unit to vary the level of engine operation, increases and decreases would be made to the engine operating level with nearly every control signal transferred to the signal. Thus, for example, the amount of fuel and the ignition timing provided to the engine might vary continuously due to fluctuations in the sensed throttle position when the operator of the vehicle desired steady-state engine operation. It is therefore desirable to filter certain sensed signals such as throttle position to minimize fluctuations due to noise and thus provide desired operation. It may also be beneficial to minimize signal noise for other reasons including, in the example of maintaining an engine at a steady operating level, reducing engine vibration that may result from the improved steady-state operation.

It should be noted that signal variations may also be caused by various signal fluctuations including electromagnetic noise. Electromagnetic noise is commonly present in signals that are transmitted electrically and may be generated in many ways including routing sensor wiring around an internal combustion engine. Where such noise is present in a signal, additional filtering, such as that performed by low-pass, high-pass, or band-pass filters may be applied in addition to the types of filtering described herein.

When a large change in a sensed value occurs, however, it is important that the changed value be reported to the data acquisition unit, such as an engine control unit, as quickly as possible so that the new demand is met as quickly as possible. Filters, such as those that use the filtering techniques of Equations 1 and 2, however, filter large changes in signal level caused by a change in the sensed characteristic or medium in equal proportion to small changes caused by noise. Thus, those filters may significantly delay recognition of a changing sensed value and implementation of control that may depend on recognition of that change.

Thus, it would be beneficial to have a filter that reduces the effect of undesirable signal fluctuations on a filtered signal and that also allows a filtered signal to react quickly to significant changes in signal level. Undesirable signal fluctuations include small changes in signal level such as noise, irregularities such as the changing velocity of a piston in a cylinder of a reciprocating internal combustion engine, and other undesirable fluctuations in signal level. In an embodiment of the present dynamic filter, the dynamic filter reduces the effect of low level signal fluctuations such as noise and irregularities on the signal or value emanating from the filter, while minimizing or eliminating the effect of the filter on the signal or value emanating from the filter when a significant change in the received signal or value occurs.

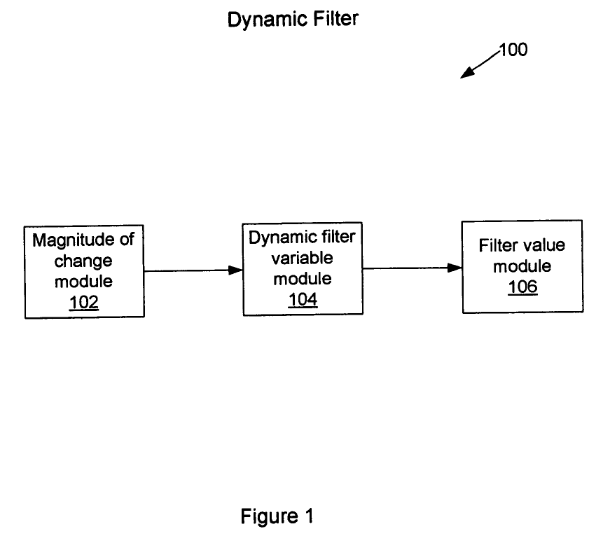

FIG. 1 illustrates an embodiment of a dynamic filter 100 that may be used to have a proportionately large filtering effect on a small change in a signal and a proportionately small filtering effect on a larger change in the signal. The dynamic filter 100 includes a magnitude of change module 102, a dynamic filter variable module 104, and a filter value module 106.

The magnitude of change module 102 calculates a magnitude that a value or signal has changed since a previous time that the value was determined or the signal was received. The time between receipt of two consecutive values or signals may be referred to as an interval. That signal or value may be a signal or value transmitted from a sensor to a processing unit and read by the processing unit or may be a value calculated by the processing unit or another device. The change may be a difference between a current reading of the sensed value and the last reading of the sensed value. Alternately, the change may be a difference between a current reading and one or more previous readings other than or including the last reading. The calculation of the magnitude of change may be represented by Vc−Vp where Vc is the current value and Vp is a previous value such as the previously calculated filter value. The resulting magnitude of change may, for example, be represented in units of the sensed value such as degrees Kelvin where the sensor is sensing and transmitting a signal or value representative of temperature or in percentage where sensor values are converted to percent such as in connection with a throttle position sensor. The absolute value of the magnitude of change may furthermore be utilized when the magnitude of change is calculated by subtracting, for example, the previous value from the current value to assure that the magnitude of change is a positive value.

The dynamic filter variable module 104 determines a value for a dynamic filter variable using the magnitude of change. The dynamic filter variable may be viewed as taking the place of the filter constant utilized in Equations 1 and 2. The dynamic filter variable may include a dynamic multiplier to be multiplied by a relative magnitude of change in the sensed value. In addition, a filter constant may be added to or subtracted from the dynamic filter variable where, for example, a shift toward the currently sensed value and away from the previously sensed value is desired.

The relative magnitude of change may be calculated by taking the absolute value of the magnitude of change and dividing that by a value to which the magnitude of change is desired to be related. That relative value used as a denominator may include, for example, the currently determined value, the previously determined value, the previous filtered value, the greater or lesser of the currently determined value and the previously determined value, the greater or lesser of the currently determined value and the previous filtered value, the range of values that may be sensed by the sensor, or a range of values that are of interest. For example, where the sensed value is throttle position and the range is 0-100%, the relative value may be the full range of 100% to give equal effect to changes throughout the range. The current or previous input value may be utilized as the relative value in place of the range when, for example, changes in the low end of the range are desired to be given greater effect than changes in the high end of the range. In the examples that follow, the lesser of the currently sensed input value and the previous filtered value is used as the relative value.

In an embodiment where the relative value used as a denominator is set to the previously determined input value, a change from 50% to 75% would provide a relative value of 50% (|75%−50%|/50%=50%) and a change from 75% to 50% would provide a relative value of 33.3% (|50%−75%|/75%=33.3%). Thus an increase of a certain magnitude and a decrease of the same magnitude provide different results.

In another embodiment where the relative value used as a denominator is set to the lesser of the previous filter value and the currently determined input value, a change from 50% to 75% would provide a relative value of 50% (|75%−50%|/50%=50%) and a change from 75% to 50% would provide a relative value of 50% (|50%−75%|/50%=50%). Thus an increase of a certain magnitude and a decrease of the same magnitude provide the same result in that embodiment. A filter utilizing that method may thus provide the same degree of filtering for signals that are increasing and signals that are decreasing.

In yet another embodiment, calculations using both the previous filtered value and the currently determined input value may be made and the lesser or greater quotient may be selected as desired.

Thus, the dynamic filter variable may be expressed as a dynamic multiplier multiplied by the absolute value of the magnitude of change and divided by the relative value, which may be an absolute value of the relative value, with a constant value added to or subtracted from the product if desired. In the following examples, the dynamic filter variable will be expressed by Equation 3.
DF=[M(|Vc−FVp|)/(lesser of |FVp| or |Vc|)]+ or −FC Dynamic Filter Variable Equation 3
where:
DF is the dynamic filter variable;
M is the dynamic multiplier and will have a value of 4.0 in the following examples but may have another value if desired;
Vc is the currently determined input value;
FVp is the previous filtered value; and
FC is the filter constant value that may be added or subtracted to arrive at the dynamic filter variable if desired and will have a value of 0.2 in the following examples.

In an embodiment, the dynamic multiplier may be viewed as increasing the significance of the change between the previous filtered value and the currently determined input value when the dynamic multiplier is set greater than one and decreasing the significance of the change between the previous filtered value and the currently determined input value when the dynamic multiplier is set less than one. Thus where no shift in significance is desired, the dynamic multiplier may be set to 1.0 or may not be utilized.

In an embodiment, the filter constant may be viewed as a limit on the maximum amount of filtering that may occur in the filter. Thus, for example, where the dynamic filter variable is to have a value between zero and one with a zero value causing the filtered value to be equal to the previous filtered value or previously determined input value, the filter constant may be utilized to prevent the dynamic filter variable from reaching zero. By doing so, the currently determined input value will play at least some part in the determination of the filtered value.

Using the sample values, where a small change occurs, such as where the currently determined value is 50% and the previous filtered value is 51%, the dynamic filter variable will be equal to 4.0 (|50%−51%|)/|50%|+0.2, or 0.28. Where a moderate change occurs, such as where the currently determined value is 50% and the previous filtered value is 60%, the dynamic filter variable will be equal to 4.0 (|50%−60%|)/50%+0.2, or 1.0. Where a large change occurs, such as where the currently determined value is 50% and the previous filtered value is 100%, the dynamic filter variable will be equal to 4.0 (|50%−100%|)/50%+0.2, or 4.2.

The dynamic filter variable may furthermore be limited to a maximum of, for example, 1.0, to prevent the filtered value resulting from the filter value module 106 discussed in more detail below from exceeding the currently determined input value, and thereby eliminating overshoot.

Likewise, if the filter constant is negative, the dynamic filter variable may be limited to a minimum value of, for example, 0.0. That may furthermore cause the filter to disregard changes in the input signal that are less than a threshold value.

As may be seen from those examples, the dynamic filter variable increases as the magnitude of change between the previously determined input value and the currently determined input value increases. Furthermore, as the dynamic filter variable increases, the filter value resulting from the dynamic filter module 106 becomes weighted more toward the currently determined input value and away from the previous filtered value or previously determined input value, thereby reducing the amount of filtering occurring when the change is greater. Conversely, as the dynamic filter variable decreases, the filter value becomes weighted more toward the previous filtered value or previously determined value and away from the currently determined value, thereby increasing the amount of filtering occurring.

The filter value module 106 may be utilized to determine a filtered value based on the dynamic filter variable. That filter value may furthermore be expressed as shown in Equation 4.
FVc=FVp+DF(Vc−FVp) Dynamic Filter Equation 4
where:
FVc is the current filtered value;
FVp is the previous filtered value;
DF is the dynamic filter variable calculated in Equation 3; and
Vc is the currently determined input value.

It should be noted that the previously determined input value Vp may be substituted for the previous filtered value FVp in Equation 4.

The dynamic filter variable may be limited to a value in a range from zero to one, wherein a value of zero provides a current filtered value (FVc) equal to the previous filtered value and a value of one provides a filtered value equal to the currently determined input value, with a filter variable value between zero and one providing a filtered value that is a portion of each of the previous filtered value and the currently determined input value. Thus, in the embodiment described in Equation 4, a dynamic filter value of zero would be equal to the previous filtered value or another previous value utilized and may not include any part of the currently determined input value. Similarly, in the embodiment described in Equation 4, a dynamic filter value of one would be equal to the currently determined input value and may not include any part of the previous filtered value or other previous value utilized.

Thus, as an example of a limit on the dynamic filter variable, in the large change example provided above, where the currently determined value is 50% and the previous filtered value is 100%, a clamp or limit of 1.0 may be utilized to limit the dynamic filter variable to 1.0, rather than permitting the dynamic filter variable to reach 4.2. A dynamic filter variable value of 1.0 causes the current filtered value resulting from the filtering process to be equal to the currently determined input value so that the output of a dynamic filter 100 utilizing Dynamic Filter Variable Equation 3 with a currently determined value of 50%, a previous filtered value of 100%, and a clamp at 1.0 would be 50%, which is the same as the 50% currently determined input value in that example.

Where the previously determined input value Vp is substituted for the previous filtered value FVp, such a dynamic filter variable limit would cause a value of zero to provide a current filtered value equal to the previously determined input value and a value of one provides a filtered value equal to the currently determined input value, with a filter variable value between zero and one providing a filtered value that is a portion of each of the previously determined input value and the currently determined input value.

The dynamic filter 100, utilizing the process described in connection with Equation 4, thus provides a filtered value that falls on or between the previous filtered value or previously determined input value and the currently determined input value as long as the dynamic filter variable has a value of or between zero and one. Notably different from the filters of Equations 1 and 2, the current dynamic filter value varies between the previous filtered value or previously determined input value and the currently determined input value dependent of the magnitude of change between the previous filtered value or previously determined input value and currently determined input value.

It may be noted that a dynamic filter variable that approaches zero provides a filtered value weighted toward the previous filtered value and that a dynamic filter variable that approaches one provides a filtered value that is weighted toward the currently determined input value in Equation 4. It may also be noted that as the relative magnitude of change increases the dynamic filter variable increases, thereby placing more weight on the currently determined input value and less weight on the previous filtered value. By placing more weight on the currently determined input value and less weight on the previous filtered value, the result is that the amount of filtering occurring when larger changes in input or sensed value occur is reduced. Likewise, the amount of filtering occurring when smaller changes in input or sensed value occur is increased to a limit of the filter constant value FC.

It should be recognized that Equation 4 may be reconfigured similarly to the way that Equation 1 was reversed to create Equation 2 if it is desired that a filter constant value of one provides a filtered value equal to the previous filtered value and a filtered constant value of zero provides a filtered value equal to the currently determined input value.

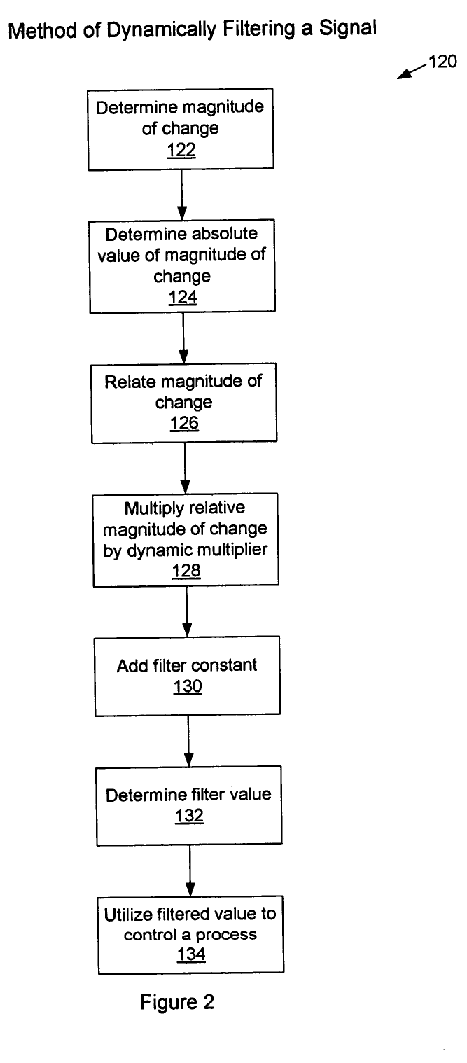

FIG. 2 illustrates an embodiment of a method of dynamically filtering a value 120. The value may, for example, be a signal received from a sensor and read periodically at an engine control unit. The value may be communicated to a processor in the engine control unit. The processor may then filter the value and utilize the filtered value to control the operation of one or more processes.

At 122-130, a dynamic filter variable is calculated for use in filtering the value, wherein the dynamic filter variable may be determined as described in connection with Equation 3. At 122, a magnitude of change is determined between a currently determined input value and a previous filtered value. The previous filtered value may represent one or more weighted, unweighted, or otherwise averaged values. At 124, the absolute value of the magnitude of change may be calculated if the magnitude of change is calculated in a way that may result in a negative value. At 126, the magnitude of change is related to a value as described hereinbefore. At 128, the relative magnitude of change may be multiplied by a predetermined dynamic multiplier if desired. At 130, a filter constant may be added to or subtracted from the filter variable if desired.

The dynamic filter value may be used in a filter such as that discussed in connection with Equation 4 to apportion a filter value between a previous value, such as a previous filtered value or a previously determined input value, and a current value, such as a currently determined input value, wherein a dynamic filter variable having a value of zero provides the full previous value and none of the current value, a filter value having a value of one provides the full current value and none of the previous value, and a dynamic filter variable having a value between zero and one provides a resulting filtered value that is apportioned between the previous and current values. At 132, the dynamic filter variable is utilized in a filter such as the filter discussed in connection with Equation 4 to determine a filtered value. The filtered value may then be used to control one or more processes at 134. The dynamic filter variable may be limited to a range of zero to one and may utilize a range other than zero to one.

The method of dynamically filtering a signal 120 may then be repeated for each determined value input into the filter.

In an embodiment, the dynamic filter may included an article of manufacture that includes a computer readable medium having stored thereon instructions which, when executed by the processor cause the processor to dynamically filter a signal as described herein. For example, the computer readable medium may include instructions to cause a processor to receive one or more values from a sensor. The values determined to be acted upon by the processor may include a stream of values that are filtered as they are received, operating on each currently sensed input value as it is received and retaining one or more previous filtered values or previously determined input values. The computer readable medium may further include instructions to cause a processor to create a filtered value including a portion of the currently determined input value and a portion of the previous filtered value or previously determined input value, the portions of those values dependent on a magnitude in change between the previously value and the current value.

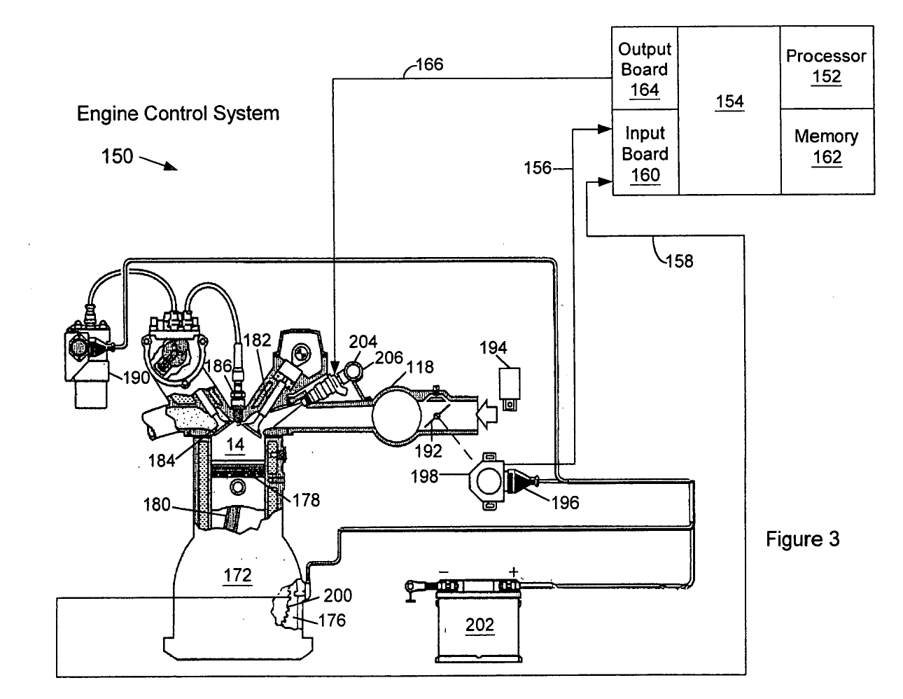

FIG. 3 illustrates an embodiment of an engine control system 150 in which the dynamic filter may be employed. The engine control system 150 includes an internal combustion engine 172 having a cylinder 174, and a crankshaft 176. The cylinder 174 contains a piston 178 having a connecting rod 180 that connects to the crankshaft 176. An intake valve 182, an exhaust valve 184 and a spark plug 186 extend into the cylinder 174.

An air intake control device 188 and a fuel supply control device 204 provide air and fuel to the intake valve 182 and the cylinder 174. The air intake control device 188 may include, for example, a butterfly valve 192 or gate valve to control the quantity of combustion air delivered to the engine 172. An air mass sensor 194 may, for example, be located in the air intake pipe.

A fuel supply control device 204 may be, for example, a fuel injector 206 or a carburetor. When using a fuel injector 206, the fuel injector 206 may include an actuator coupled thereto to control fuel flow through the fuel injector 206. A signal, such as a pulse-width modulated signal, may be transmitted from the engine control unit 150 to the actuator to provide fuel flow through the fuel injector 206.

A throttle position sensor 196 may be attached to sense the position of an operator control 198 or a throttle butterfly valve 192 as an indicator of engine load. A crankshaft encoder 200 or other device may sense rotation of the crankshaft 176 as an indicator of engine speed. A battery 202 may provide power to portions of the engine control system 150 requiring electrical power.

The components of the engine control system 150 may operate in a known fashion, while control of, for example, the amount of fuel to be provided by the fuel supply device 204 may be varied by the engine control unit 150 utilizing the dynamic filter 100 illustrated in FIG. 1 or the method of dynamically filtering a value 120 illustrated in FIG. 2. For example, in the engine control system 150 of FIG. 3 an embodiment of the dynamic filter may be performed by the processor 152 in the engine control unit 154. In that embodiment, one or more input signals 156 and 158 to be filtered are received at an input board 160 in the engine control unit 154.

The processor 152 may be coupled to memory 162 and may execute program instructions and process information stored in the memory 162. Information may comprise any data capable of being represented as a signal, such as an electrical signal, optical signal, acoustical signal and so forth. Examples of information in this context may include historical and current sensed values.

In one embodiment, the instructions are stored in memory 162. As used herein the phrase, “executed by a processor” is intended to encompass instructions stored in a machine readable format, as well as instructions that may be compiled or installed by an installer before being executed by the processor 152.

The memory 162 may, for example, include cache, random access memory (RAM) such as dynamic RAM or static RAM, read only memory (ROM) such as programmable ROM, erasable programmable ROM, or electronically erasable programmable ROM, or mass storage devices such as a magnetic disk or optical disk. The memory 162 may store computer program instructions and information. The memory 162 may furthermore be partitioned into sections including an operating system partition, wherein instructions including those for performing dynamic filtering may be stored, and a data partition in which information such as the one or more previous values may be stored

The signals 156 and 158 are received from a throttle position sensor and from a crankshaft position sensor, respectively in the engine control system 150 illustrated in FIG. 3. The input board 160 receives and samples the signals 156 and 158 and provides a value corresponding to the sensed value incident on each signal 156 and 158 to the processor 152. The processor 152 may then execute instructions that cause the processor to convert the values corresponding to the sensed values incident on each signal 156 and 158 to values having engineering units appropriate for the characteristics sensed, such as position in percent for the throttle position sensor 196 and rotations per minute or rpm for the engine rotational speed sensor 200. The processor 152 may then execute instructions that cause the processor to dynamically filter those converted sensed values as is described herein. The processor 152 may furthermore provide one or more outputs through an output board 164, such as output 166 to, for example, a fuel supplying device such as the fuel injector 206 illustrated, determined from the dynamic filtering of the converted sensed values.

It should be recognized that the sensed throttle position example has been used herein to exemplify and explain issues related to noisy signals and it should be recognized that filters such as those described herein may be applied to any noisy signal application and any other application in which small fluctuations in a signal or a series of values are to be minimized while a reaction is to be made quickly to larger fluctuations.

1. A filtered value, comprising:
a portion of a previously determined value; and
a portion of a currently determined value, the portions of the previously determined value and the currently determined value varying dependent on a magnitude of change between the previously determined value and the currently determined value such that the filtered value is biased toward the previously determined value when the magnitude of change is small and biased more toward the currently determined value when the magnitude of change is larger.

2. The filtered value of claim 1, wherein the previously determined value is a previously determined filtered value.

3. The filtered value of claim 1, wherein the previously determined value is related to a sensed characteristic.

4. The filtered value of claim 1, wherein the magnitude of change includes dividing a difference between the previously determined value and the currently determined value by a relative value.

5. The filtered value of claim 4, wherein the difference between the previously determined value and the currently determined value is the absolute value of the difference between the previously determined value and the currently determined value.

6. The filtered value of claim 4, wherein the relative value includes one of the previously determined value, the currently determined value, the lesser of the previously determined value and the currently determined value, the greater of the previously determined value and the currently determined value, a predetermined value, and at least a portion of a range of a sensor to which the previously determined value and the currently determined value are related.

7. The filtered value of claim 4, wherein the significance of the magnitude of change is modified by a multiplier.

8. The filtered value of claim 4, wherein the magnitude of change further comprises limiting the filter by adding a filter constant to the magnitude of change.

9. The filtered value of claim 1, wherein the filtered value is limited to the range from the previously determined value to the currently determined value.

10. The filtered value of claim 1, wherein the currently determined value and the previously determined value are related to a characteristic of one of a device and a process.

11. The filtered value of claim 10, wherein the filtered value is used to control one of the device and the process.

12. A filter comprising:
a processor executing instructions that cause the processor to:
receive a current value;
retain a previous value; and
create a filtered value including a portion of the current value and a portion of the previous value, the portions of the previous value and the current value varying dependent on a magnitude of change between the previous value and the current value such that the filtered value is biased toward the previous value when the magnitude of change is small and biased more toward the current value when the magnitude of change is larger.

13. The filter of claim 12, wherein the previous value is a previously determined filtered value.

14. The filter of claim 12, wherein the current value and the previous value are associated at least in part with a sensed characteristic obtained by the processor from one of a device and a process.

15. The filter of claim 14, wherein the processor further executes instructions that cause the filtered value to be utilized to control an aspect of one of the device and the process.

16. The filter of claim 12, wherein the processor determines the magnitude of change at least in part by dividing a difference between the previous value and the current value by a relative value.

17. The filter of claim 16, wherein the relative value includes one of the previous value, the current value, the lesser of the previous value and the current value, the greater of the previous value and the current value, a predetermined value, and at least a portion of a range of a sensor to which the previous value and the current value are related.

18. A filter comprising:
a magnitude of change module that determines a magnitude of change from a previously determined value to a currently determined value;
a dynamic filter variable module that relates the magnitude of change to a relative value; and
a filter value module that applies the relative magnitude of change to the magnitude of change and combines the result with the previously determined value to arrive at a filtered value, wherein the filtered value is biased toward the previously determined value when the magnitude of change is small and the filtered value is biased more toward the currently determined value when the magnitude of change is larger.

19. The filter of claim 18, wherein the currently determined value is related to a currently sensed characteristic of one of a device and a process and the previously determined value is a previously determined filter value.

20. The filter of claim 18, wherein the currently determined value is related to a currently sensed characteristic of one of a device and a process and the previously determined value is related to a previously sensed characteristic of one of the device and the process.

21. A method of filtering a value, comprising combining a portion of a previously determined value with a portion of a currently determined value, the portions of the previously determined value and the currently determined value varying dependent on a magnitude of change between the previously determined value and the currently determined value such that the filtered value is biased toward the previously determined value when the magnitude of change is small and biased more toward the currently determined value when the magnitude of change is larger.

22. The method of filtering a value of claim 21, wherein the previously determined value is a previously determined filtered value.

23. The method of filtering a value of claim 21, wherein the magnitude of change includes dividing a difference between the previously determined value and the currently determined value by a relative value.

24. The method of filtering a value of claim 23, wherein the difference between the previously determined value and the currently determined value is the absolute value of the difference between the previously determined value and the currently determined value.

25. The method of filtering a value of claim 23, wherein the relative value includes one of the previously determined value, the currently determined value, the lesser of the previously determined value and the currently determined value, the greater of the previously determined value and the currently determined value, a predetermined value, and at least a portion of a range of a sensor to which the previously determined value and the currently determined value are related.

26. The method of filtering a value of claim 23, wherein the significance of the magnitude of change is modified by a multiplier.

27. The method of filtering a value of claim 23, wherein the magnitude of change further comprises limiting the filter by adding a filter constant to the magnitude of change.

28. The method of filtering a value of claim 21, wherein the filtered value is limited so as not to fall outside of the range from the previously determined value to the currently determined value.

29. The method of filtering a value of claim 21, wherein the currently determined value and the previously determined value are related to a characteristic of one of a device and a process.

30. The method of filtering a value of claim 29, wherein the filtered value is used to control one of the device and the process.

31. A computer readable medium having stored thereon instructions which, when executed by a processor, cause the processor to:
receive a current value;
retain a previous value; and
create a filtered value including a portion of the current value and a portion of the previous value, the portions of the previous value and the current value varying dependent on a magnitude in change between the previous value and the current value such that the filtered value is biased toward the previous value when the magnitude of change is small and biased more toward the current value when the magnitude of change is larger.

32. The computer readable medium of claim 31, wherein the previous value is a previously determined filtered value.

33. The computer readable medium of claim 31, wherein the previous value is related to a characteristic of one of a device and a process sensed by the processor.

34. The computer readable medium of claim 31, wherein the instructions cause the processor to determine the magnitude of change at least in part by dividing a difference between the previous value and the current value by a relative value.

35. The computer readable medium of claim 34, wherein the relative value includes one of the previous value, the current value, the lesser of the previous value and the current value, the greater of the previous value and the current value, a predetermined value, and at least a portion of a range of a sensor to which the previous value and the current value are related.
